(19) United States
(12) Patent Application Publication
(10) Pub. No.: US 2020/0361832 A1
(43) Pub. Date: Nov. 19, 2020

(54) EFFECTIVENESS OF WATER SOLUBLE PAM

(71) Applicant: Allen Pyle, Green Bay, WI (US)

(72) Inventor: Allen Pyle, Green Bay, WI (US)

(21) Appl. No.: 15/931,038

(22) Filed: May 13, 2020

Related U.S. Application Data
(60) Provisional application No. 62/847,564, filed on May 14, 2019.

(51) Int. Cl. C05G 3/80; C09K 17/22; C09K 17/52; C05F 11/02; C05G 5/12; C05G 5/27; A01C 21/00

(52) U.S. Cl. CPC C05G 3/80; C09K 17/22; C09K 17/52; A01C 21/00; C05G 5/12; C05G 5/27; C05F 11/02

(57) ABSTRACT

A compound and method that improves the effectiveness of water soluble polyacrylamide placed on the soil that comprises WSPAM and humic compounds.

### RELATED APPLICATIONS

This application claims priority to provisional application 62/847,564 filed May 14, 2019.

### FIELD OF THE INVENTION

The present invention relates to compounds and methods for improving the effectiveness of water-soluble polyacrylamide as a soil amendment.

### BACKGROUND OF THE INVENTION

U.S. Pat. No. 4,081,402 relates to an absorbent material for treating industrial wastewater by column filtration. The material is composed of a granular material obtained by subjecting a mixture of an activated sludge-containing material and a primary condensate of a formaldehyde type resin and/or a dialdehyde compound to heat-curing and granulating.

U.S. Pat. Nos. 6,818,596 and 7,351,680 relate to a petroleum drilling mud fluid using partially hydrolyzed polyacrylamide (PHPA) and polyanionic cellulose polymer (PAC) and leonardite/humic acid as a “hydration buffer” to help keep powder or pellets dry and flowable.

U.S. Pat. No. 8,256,158 relates to visual attenuation colored compounds for landscape camouflage of disturbed areas. It can be applied via hydrospraying. The compounds include a colorant selected from the group consisting of a pigment, a dye, and combination thereof, and optionally includes an additive selected from the group consisting of a flocculent, a tackitier, a stabilizer, and combination thereof.

U.S. Pat. No. 8,440,230 relates to a formulation based on micronized natural calcite mineral consisting of a mineral consisting of a mixture of calcium carbonate, an adjuvant selected from a wetting agent, drill control agent, drifting control agent at application by spraying, humic acid, salt, micro-nutrients, etc. The formulation is used as a plant booster and mineral fertilizer for stimulation of photosynthetic process in plants.

U.S. Pat. No. 10,172,293 relates to soil remediation and soil pore stabilizing compounds designed to stabilize soil structures comprising at least one electrolyte and at least one cofactor.

U.S. Pat. No. 10,259,753 relates to a fertilizer formulation with a wide range of properties including a plant biostimulant. Color indicators can be included to indicate the pH of the solution being applied.

US patent publication 20130014434 relates to a composite delivery and nutrient system for agriculture and nursery uses. The method and device contain the roots of the plant comprising a base sheet of material containing at least one selected area on the sheet facing the roots, the at least one selected area containing selected nutrients for promoting plant or root growth.

US patent publication 20180359933 relates to a soil remediation and soil pore stabilizing composition comprising at least one electrolyte and at least one cofactor.

U.S. Pat. No. 7,503,143 relates to a method of applying PAM to soil wherein PAM is impregnated and/or applied to solid carriers that are placed onto the soil and after the application of water, the PAM leaches out and binds to the soil.

U.S. Pat. No. 7,874,101 relates to a method for applying water soluble soil stabilizer wherein the water soluble soil stabilizer is impregnated and/or applied to solid carriers that are placed onto the soil and after application of water, the water soluble soil stabilizer leaches out and binds to the soil.

U.S. Pat. No. 8,316,580 relates to a method of applying water soluble soil stabilizer to soil comprising adding water soluble soil stabilizer to solid carrier; releasing water soluble soil stabilizer out of solid carrier; water soluble soil stabilizer binds to soil; solid carrier is a soil stabilizer, mulch or biosolid.

U.S. Pat. No. 9,441,349 relates to a method of applying water soluble soil stabilizer (WSSS) to a solid carrier for applying to soil; impregnating, applying or adding WSSS to a solid carrier; WSSS within or on the solid carrier; WSSS leaches out of the solid carrier when water is applied; WSSS binds to the soil; WSSS is added to the carrier in an intentional amount.

U.S. patent Ser. No. 10/544,364 relates to a control product that binds soil particles together. The control product comprises a solid carrier and water soluble soil stabilizer (WSSS). The WSSS is impregnated or applied to the control product. An intentional amount of WSSS leaches out and binds the soil particles together.

U.S. Pat. No. 8,925,244 relates to a method of controlling the movement of biosolids before, during and after application. The method aids in management of problematic movement (i.e., runoff and leaching) of biosolids' components harmful to human and environmental health. The method requires that water-soluble polyacrylamide be combined with the biosolids prior to land exposure.

### SUMMARY OF THE INVENTION

The present invention relates to improving the effectiveness of water soluble polyacrylamide, PAM. The effectiveness of water-soluble anionic polyacrylamide (WSPAM) as a soil amendment is improved when combined with humic compounds. It is an object of the present invention to significantly improve WSPAM's ability to stabilize soil particles and reduce the loss of plant nutrients through leaching, runoff, and erosion with the addition of humic compounds. It is the object of the present invention for the humic compounds to include humic acids, fulvic acids and humins.

Humic compounds help to produce good soil structure, improving both water infiltration and soil water holding capacity. Humic compounds further benefit soil structure by producing stable soil aggregates. These compounds also affect certain plant nutrients, including trace elements. Humic compounds chelate these elements, making them more available to plants as well as binding them to soil particles, reducing their likelihood to be lost through erosion, leaching or runoff.

The most common source of humic compounds for use as a soil amendment is from mixed leonardite, which is formed by oxidation of lignite. Plants can also be a source of humic compounds. It is an object of the present invention for the humic compound to comprise Tannin, a type of humic acid, a phenolic compound produced by certain plants.

It is an object of the present invention for humic compounds to be included in pelletized fertilizer products. It is an object of the present invention for the humic compounds to be included into products containing seed plus fertilizer and mulch. It is an object of the present invention for the humic compounds to be included into products containing seed plus fertilizer and soil improvers. It is an object of the present invention for the humic compounds to be incorporated into fertilizer and mulch granules as dry powder or applied as dry powder after treatment with WSPAM emulsion.

WSPAM is a very effective soil amendment at low application rates. It is an object of the present invention to combine humic compounds with WSPAM in terms of improved infiltration in soil, increased water holding capacity of the soil, and increased nutrient retention in soils.

The effect of increasing the effectiveness of WSPAM is in part due to the very large cation exchange capacity of humic compounds. The combination of humic compounds and WSPAM increases the number of potential binding sites for WSPAM to attach to both soil particles and to plant nutrient cations in the soil solution. WSPAM has been found to be more effective in soils with higher cation exchange capacity (CEC). The application of animal manures, which increase soil organic matter, is one way to increase CEC of soils.

It is an object of the present invention to combine WSPAM and humic compounds in fertilizer or mineral compounds.

It is an object of the present invention to apply WSPAM in fertilizer or mineral compounds at a rate of approximately 0.25% to 1.5% of the total product weight.

It is an object of the present invention for the WSPAM compound to further comprise a surfactant.

It is an object of the present invention for the WSPAM compound to be applied to the soil in dry form.

It is an object of the present invention to combine PAM with compounds that create more receptor sites.

It is an object of the present invention for the PAM compound to be provided to the soil in a broadcast application in combination with fertilizer.

It is an object of the present invention for the PAM to be provided to a carrier, such as mulch, fertilizer, minerals or any combination, at an application rate which allows the PAM to bind to the soil particles.

It is an object of the present invention for applying the PAM and humic compound by impregnating and/or applying it to solid carriers. The solid carriers can be comprised of organic and/or inorganic materials that can be applied to soil. These materials may contain fertilizers, soil amendments, soil conditioners, and/or waste products. The solid carrier can be produced by agglomeration. Other terms commonly used to describe agglomeration is granulation and compaction as they both relate to particle size enlargement. The solid carrier acts as a delivery system for the PAM compounds. By controlling the rate of solid carrier metered to the soil, a user in turn, controls the amount of PAM compound metered to the soil. The present invention relates to any solid carrier that can be applied through conventional means, such as, spreaders. In a preferred embodiment, industries that use this technology include agricultural and horticulture.

The present invention relates to adding the PAM compound to a solid carrier, applying the solid carrier to the soil; applying water to the solid carrier; and leaching PAM compound out of the solid carrier into the soil. The water can be natural in the form of rain or applied by man-made means. It is an object of the present invention for the PAM to be in a dry granular form. It is an object of the present invention for the PAM to be in a liquid emulsion form. It is an object of the present invention for the solid carrier to comprise a mulch or fertilizer. It is an object of the present invention to add fertilizers and/or soil amendments to the solid carrier. It is an object of the present invention for the solid carrier to comprise fibrous material. It is an object of the present invention for the solid carrier to be in the form of a granule, extruded pellet, woven mat, flake and/or formed bale and/or size reduced particle. It is an object of the present invention for the solid carrier to contain a seed. It is an object of the present invention to add pesticides or herbicides to the solid carrier. It is an object of the present invention to add fertilizer to the solid carrier. It is an object of the present invention for the solid carrier used to apply PAM compound to soil to comprise mulch and PAM compound.

It is an object of the present invention to add aluminum sulfate and/or calcium oxide to the solid carrier. The addition of these elements with PAM compound assists in slowing down the loss of phosphorous in runoff.

Solid carriers can be made by a number of ways of agglomeration processes, including agitation, pressure, liquid and thermal. Agitation agglomeration includes the methods: tumbling, mixing, granulation, pelletizing, balling, conditioning, and instantizing. Pressure agglomeration includes the methods: briquetting, compacting, extrusion, pelleting, molding, tabletting and isostatic pressing. Liquid agglomeration includes the methods: spray drying, spray granulation, fluid bed granulation, prilling, agglomeration in liquid media, oil agglomeration and globulation. Thermal agglomeration includes the methods: sintering, induration, nodulizing, calcining, drying/solidification, partial gasification/charring, and flaking.

Agitation agglomeration can use the following equipment: mixers (planetary, cone, ribbon, pin type, drum, counter-current, vertical, paddle, pugmills), disc pelletizers (pan granulators), drum pelletizers and cone pelletizers. Pressure agglomeration can use the following equipment: roller presses (roll briquetters, roll compactors), piston/ram presses, pellet mills (ring die, flat die), extruders (auger, screw, screen, basket), tablet presses. Liquid agglomeration can use the following equipment: spray dryers, prill towers, spray/fluid bed, granulators, mixers for oil agglomeration. Thermal agglomeration can use the following equipment: sinter strands, travelling grates, rotary kilns, shaft furnaces and drum/belt flakers.

Solid carriers can also be made via a process of size reduction wherein a material is reduced into smaller particle sizes. In an embodiment, the solid carrier is comprised of materials that are not in a liquid or slurry state.

Water soluble polyacrylamides (PAMs) have been proposed as soil amendments for various agricultural purposes. Water soluble polymers, generically described as polyacrylamides (PAMs) appear to have a variety of beneficial soil amendment properties, including minimization of water run-off, erosion, crusting, and stabilization of soil structure. This benefit extends to the general reduction of runoff of fertilizer, pesticide and herbicide.

PAM is a long chain synthetic polymer that acts as a strengthening agent, binding soil particles together. It is harder for water to move these larger, heavier particles of soil. PAM applied in the irrigation water reduced soil erosion in furrows by over 95 percent, when compared to irrigation without the polymer.

Though the PAM compound can be incorporated in any physical state into the solid carrier under the current invention, dry PAM compound is preferred because it impregnates easier into the solid carrier then other forms of PAM compound. Also dry PAM compound can be stored and may be the least expensive form. Further, by applying PAM compound by the method of the present invention, application equipment does not tend to plug, nor does weed screens and filters. There is no danger from choking from inhalation of PAM dust while filling machine. If one were to apply dry PAM directly to a field, there would be greater PAM losses from the field since there is less control of dissolution. Further by applying dry PAM directly to the soil there is poorer uniformity of distribution than the present invention. The rate of PAM addition must be based on total irrigation inflow rate, erosion potential for a field, and desired injection concentration.

Another preferred type of PAM is PAM emulsion, in which fine dry PAM is dissolved in an oil solution. This allows for spray application. After spraying, additional dry PAM or other dry ingredients can be applied to the oil emulsion, helping them adhere.

Application rates of anionic PAM mixtures may need to be adjusted based on soil type, slope, and type of erosion targeted (i.e., wind or water). Anionic PAM mixtures may be applied to steeper slopes when used with other erosion control BMPs such as seed and mulch or erosion mat.

### DETAILED DESCRIPTION OF THE INVENTION

In ajar test using a composted chicken manure fertilizer dissolved in deionized water, the addition of 0.6% tannin and 0.25% WSPAM (by weight) was sufficient to produce significant reduction of multiple nutrients in supernatant liquid after 24 hours of settling. Significant reductions were seen for phosphorous, potassium, calcium, sulfur, and silicon. This indicates these nutrients are retained in the dissolved fertilizer pellets, reducing the potential that they could be lost by leaching or runoff.

In jar tests using soil dissolved in water plus mineral soil amendments such as gypsum or lime treated with 1.5% WSPAM, soil particles quickly precipitate (flocculate) when the WSPAM dissolves after stirring. By adding a small amount of tannin (0.02 grams added to 500 ml water in the jar), additional soil particles in solution quickly precipitate, leaving the resulting water visibly clearer compared to WSPAM alone.

### Example 1

A soil amending granule is produced by pelletizing anaerobically digested manure, gypsum, and calcitic limestone through an agglomeration process. In agglomeration, digested dairy manure is combined with gypsum and limestone in a pin mixer or paddle mixer. After mixing, the resulting granules are further processed in a pan pelletizer (pan granulator) before being dried in a rotary dryer. ARer drying, product is screened to ensure consistency in size, removing dust and undersized granules. Screenings are recycled back into the mix in the paddle mixer to improve production efficiency and minimize waste. An oil emersion of WSPAM is sprayed onto finished granules at a rate of 0.8% by weight. After WSPAM application, dry tannin is applied at 0.5% of weight.

### Example 2

A soil amending granule is produced by extrusion of aerobically composted dairy manure, gypsum, and calcitic limestone. After extrusion, the pellets sprayed with an oil emulsion of WSPAM at a rate of 0.8% by weight. After WSPAM application, dry tannin is applied at 0.5% of weight.

### Example 3

A fertilizer granule produced through extrusion, composed of aerobically composted chicken manure, blood meal, feather meal, bone meal and sulfate of potash. After extrusion, the granules are crushed in a roller and sprayed with an oil emulsion of WSPAM at 1% by weight. After WSPAM application, dry tannin is applied at 0.75% of weight. By varying the proportions of the ingredients, fertilizers can be made with a range of nutrient values for nitrogen (N), phosphorous (P) and potassium (K). For instance, a 5-5-5 NPK all-purpose fertilizer, a 2-7-7 fertilizer designed for optimizing growth of flowering plants, or a 3-8-7 fertilizer designed for garden vegetables. Optional ingredients can be added to provide further benefits to plant growth and soil health, including additional humic substances, mineral substances containing micronutrients and seaweed extract.

1. A method for improving the effectiveness of water soluble acrylamide placed on the soil comprising:
providing water soluble PAM and humic compounds in a carrier;
providing said carrier to soil;
increasing number of potential binding sites for WSPAM to attach to both soil particles and to plant nutrient in said soil.

2. The method of claim 1 wherein said WSPAM's ability to stabilize soil particles and reduce loss of plant nutrients through leaching, runoff, and erosion is improved.

3. The method of claim 1 wherein said humic compound comprises humic acids, fulvic acids and humins.

4. The method of claim 1 wherein said humic compounds assist with soil structure, improving both water infiltration and soil water holding capacity.

5. The method of claim 1 wherein said humic compounds benefit soil structure by producing stable soil aggregates.

6. The method of claim 1 wherein said humic compounds affect certain plant nutrients, including trace elements.

7. The method of claim 6 wherein said humic compounds chelate said trace elements, making them more available to plants as well as binding them to soil particles, reducing their likelihood to be lost through erosion, leaching or runoff.

8. The method of claim 1 wherein said humic compounds comprise leonardite, which is formed by oxidation of lignite.

9. The method of claim 1 wherein said humic compounds are from plants.

10. The method of claim 1 wherein said humic compound comprise tannin, a type of humic acid, a phenolic compound produced by certain plants.

11. The method of claim 1 wherein said PAM and humic compounds are included in a pelletized fertilizer product, into products containing seed plus fertilizer and mulch or into products containing seed plus fertilizer and soil improvers.

12. The method of claim 1 wherein said PAM and humic compounds are incorporated into fertilizer and mulch granules as dry powder or applied as dry powder after treatment with WSPAM emulsion.

13. The method of claim 1 wherein said PAM and humic compounds are applied in fertilizer and mulch granules as an oil emulsion PAM spray and dry humic compounds.

14. The method of claim 1 wherein said humic compounds and WSPAM improve infiltration in soil, increase water holding capacity of said soil, and increase nutrient retention in said soil.

15. The method of claim 1 wherein said carrier is a fertilizer or mineral compound.

16. The method of claim 15 wherein said WSPAM and said humic compound in said fertilizer or mineral compound is approximately 0.25% to about 1.5% of the total product weight.

17. The method of claim 1 wherein said compound further comprises a surfactant.

18. The method of claim 1 wherein said WSPAM compound is applied in a dry form.

19. The method of claim 1 wherein said WSPAM compound is applied in an oil emulsion form

20. The method of claim 1 wherein said PAM compound is provided to a carrier, such as a mulch, fertilizer, minerals or any combination thereof, at an application rate which allows said PAM compound to bind to the soil particles.

21. The method of claim 1 wherein said PAM and humic compounds are impregnated or applied to said solid carrier.

22. The method of claim 1 wherein said solid carrier is produced by agglomeration.
